(19) United States
(12) Patent Application Publication
(10) Pub. No.: US 2026/0073220 A1
(43) Pub. Date: Mar. 12, 2026

(54) ELECTRONIC DEVICE AND METHOD FOR PRUNING A NEURAL NETWORK

(71) Applicants: HYUNDAI MOTOR COMPANY, Seoul (KR); KIA CORPORATION, Seoul (KR)

(72) Inventors: Won Seok Jeon, Hwaseong-si (KR); Ju Young Yang, Hwaseong-si (KR); Byeong Wook Jeon, Hwaseong-si (KR)

(73) Assignees: HYUNDAI MOTOR COMPANY, Seoul (KR); KIA CORPORATION, Seoul (KR)

(21) Appl. No.: 19/216,275

(22) Filed: May 22, 2025

(30) Foreign Application Priority Data
Sep. 11, 2024 (KR) 10-2024-0124127

(51) Int. Cl. G06N 3/082

(52) U.S. Cl. CPC G06N 3/082

(57) ABSTRACT

An electronic device includes a memory storing computer-readable instructions and at least one processor that coupled to the memory and configured to execute the computer-readable instructions. The at least one processor is configured to identify one or more merge layers included in a pruning target model of a neural network and generate a target group including a target merge layer among the one or more merge layers and a sub-layer logically connected with the target merge layer. The processor is configured to apply a learnable mask to the target group and update the learnable mask, through propagation of the pruning target model. The processor is also configured to perform pruning of the pruning target model based on the updated learnable mask.

### CROSS-REFERENCE TO RELATED APPLICATION

This application claims the benefit of and priority to Korean Patent Application No. 10-2024-0124127, filed on Sep. 11, 2024, the entire contents of which are hereby incorporated herein by reference.

### TECHNICAL FIELD

The present disclosure relates to an electronic device and a method for pruning a neural network, and more particularly, relates to technologies for weight lightening of the neural network.

### BACKGROUND

Deep learning architectures, particularly, convolutional deep neural networks may be used in artificial intelligence (AI) and computer vision technologies. Such architectures may generate results of tasks including object recognition, detection, and segmentation. If parameters of the neural network are reduced, loads on neural network hardware may be reduced, whereas the level of performance for an image recognition task may be maintained. Particularly, to reduce a parameter size of the neural network, neural networks may be pruned to make a plurality of parameters “0”. However, there may occur a problem in equally regarding importance of each of all layers in a group and omitting more important weights upon pruning, such that a layer of each of the neural networks prunes networks as many as possible.

Particularly, if group-based pruning is adopted for weight lightening of a complex network, there may be a difference in importance of each layer between groups and in the group, but there is no direct adjustment for it. As a result, if pruning without regard to importance proceeds in the group, a network may deteriorate in performance.

The statements in this Background section merely provide background information related to the present disclosure and may not constitute prior art.

### SUMMARY

The present disclosure has been made to solve the above-mentioned problems occurring in the prior art while advantages achieved by the prior art are maintained intact.

Aspects of the present disclosure provide an electronic device and a method for pruning a neural network by individually applying importance between groups to proceed with pruning, in group-based pruning.

Aspects of the present disclosure provide an electronic device for performing pruning of a pruning target model, based on a learnable mask, to individually apply importance between groups to proceed with pruning, in group-based pruning, and a method for pruning of a neural network.

Other aspects of the present disclosure provide an electronic device for controlling a mobility system based on a pruning target model, pruning of which is performed, to apply a more optimized AI model to an environment with a limited computational resource and a method for pruning of a neural network.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, an electronic device is provided. The electronic device includes a memory storing computer-readable instructions and at least one processor configured to execute the computer-readable instructions. The at least one processor is configured to identify one or more merge layers included in a pruning target model of a neural network. The at least one processor is also configured to generate a target group including layers, the layers including i) a target merge layer among the one or more merge layers and ii) a sub-layer logically connected with the target merge layer. The at least one processor is additionally configured to apply a learnable mask which is the basis of pruning of the pruning target model to the target group. The at least one processor is further configured to update the learnable mask, through propagation of the pruning target model. The at least one processor is also configured to perform the pruning of the pruning target model, to generate a pruned target model, based on the updated learnable mask.

In an embodiment, the at least one processor may be configured to identify the one or more merge layers based on a computational graph of the pruning target model.

In an embodiment, the at least one processor may be configured to receive input data and target data, initialize parameters of the pruning target model, apply the input data to the pruning target model to propagate the pruning target model, and update the learnable mask, based on comparison between a temporary output obtained by propagating the pruning target model and the target data.

In an embodiment, the at least one processor is configured to initialize parameters of the pruning target model by initializing all parameters of the pruning target model.

In an embodiment, the at least one processor may be configured to obtain a first loss based on a difference between the temporary output and the target data. The at least one processor may also be configured to obtain a second loss of a regularization term based on whether a predetermined value is included in the learnable mask. The at least one processor may further be configured to update the learnable mask based on the first loss and the second loss.

In an embodiment, the at least one processor may be configured to change values included in the layers included in the target group to a predetermined value to perform the pruning of the pruning target model based on the updated learnable mask.

In an embodiment, the at least one processor may be configured to determine whether the pruning target model satisfies a predetermined converge criterion. The at least one processor may be configured to perform pruning of the pruning target model by applying the learnable mask to the target group based on determining that the pruning target model does not satisfy the predetermined converge criterion.

In an embodiment, the at least one processor may be configured to set a size of the learnable mask to a channel size of the target group.

In an embodiment, the at least one processor may be configured to identify a first merge layer and a second merge layer from the one or more merge layers. The at least one processor may also be configured to generate a first target group including layers, the layers including the first merge layer and a first sub-layer logically connected with the first merge layer. The at least one processor may further be configured to generate a second target group including the second merge layer and a second sub-layer logically connected with the second merge layer. The at least one processor may additionally be configured to apply a first learnable mask to the first target group and may apply a second learnable mask to the second target group, the first learnable mask and the second learnable mask being different from each other. The at least one processor may further be configured to update the first learnable mask and the second learnable mask to perform the pruning of the pruning target model.

In an embodiment, the at least one processor may be configured to apply mobility data to the pruned target model to obtain an output and may apply the output to a mobility system to control the mobility system.

According to another aspect of the present disclosure, a method is provided. The method includes identifying at least one merge layer included in a pruning target model of a neural network. The method also includes generating a target group including layers, the layers including i) a target merge layer among the one or more merge layers and ii) a sub-layer logically connected with the target merge layer. The method additionally includes applying a learnable mask to the target group and updating the learnable mask through propagation of the pruning target model. The method further includes performing pruning of the pruning target model, to generate a pruned target model, based on the updated learnable mask.

In an embodiment, identifying the one or more merge layers may include identifying the one or more merge layers based on a computational graph of the pruning target model.

In an embodiment, updating the learnable mask may include receiving input data and target data, initializing parameters of the pruning target model, applying the input data to the pruning target model to propagate the pruning target model, and updating the learnable mask, based on comparison between a temporary output obtained by propagating the pruning target model and the target data.

In an embodiment, initializing parameters of the pruning target model includes initializing all parameters of the pruning target model.

In an embodiment, updating the learnable mask may include obtaining a first loss, based on a difference between the temporary output and the target data, obtaining a second loss of a regularization term, based on whether a predetermined value is included in the learnable mask, and updating the learnable mask, based on the first loss and the second loss.

In an embodiment, performing the pruning of the pruning target model may include changing values included in the layers included in the target group to a predetermined value to perform the pruning of the pruning target model based on the updated learnable mask.

In an embodiment, performing the pruning of the pruning target model may include determining whether the pruning target model satisfies a predetermined converge criterion and performing the pruning of the pruning target model from applying the learnable mask to the target group based on determining that the pruning target model does not satisfy the predetermined converge criterion.

In an embodiment, performing the pruning of the pruning target model may include setting a size of the learnable mask to a channel size of the target group.

In an embodiment, performing the pruning of the pruning target model may include identifying a first merge layer and a second merge layer from the one or more one merge layers, generating a first target group including the first merge layer and a first sub-layer logically connected with the first merge layer, generating a second target group including the second merge layer and a second sub-layer logically connected with the second merge layer, applying a first learnable mask to the first target group and applying a second learnable mask to the second target group, the first learnable mask and the second learnable mask being different from each other, and updating the first learnable mask and the second learnable mask to perform the pruning of the pruning target model.

In an embodiment, the method may further include applying mobility data to the pruned target model to obtain an output and applying the output to a mobility system to control the mobility system.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a drawing illustrating a block diagram of an electronic apparatus according to an embodiment of the present disclosure;

FIG. 2 is a flowchart for describing a method for performing pruning of a neural network in a processor according to an embodiment of the present disclosure;

FIG. 3 is a drawing illustrating an example of not performing group-based pruning;

FIG. 4 is a drawing illustrating an example of performing group-based pruning;

FIG. 5 is a drawing illustrating a computational graph for describing a method for identifying a merge layer, in an electronic device according to an embodiment of the present disclosure;

FIGS. 6 and 7 are drawings illustrating an example of performing group-based pruning depending on importance of each of groups, in an electronic device according to an embodiment of the present disclosure;

FIG. 8 is a flowchart for describing a method for performing pruning and training of a neural network, in an electronic device according to an embodiment of the present disclosure;

FIG. 9 is a drawing illustrating an example of a pseudo code of instructions executed by a processor, in an electronic device according to an embodiment of the present disclosure; and

FIG. 10 is a drawing illustrating a computing system associated with an electronic device or a method for performing pruning of a neural network according to an embodiment of the present disclosure.

With regard to description of drawings, the same or similar denotations may be used for the same or similar components.

### DETAILED DESCRIPTION

Hereinafter, embodiments of the present disclosure are described in detail with reference to the accompanying drawings. In adding the reference numerals to the components of the accompanying drawings, it should be noted that the identical components are designated by the identical numerals even when the components are displayed on different drawings. In addition, a detailed description of well-known features or functions has been omitted where it was determined that the detailed description would unnecessarily obscure the gist of the present disclosure.

Various embodiments of the present disclosure are described below with reference to the accompanying drawings. However, it should be understood that this is not intended to limit the present disclosure to specific implementation forms. Rather, the present disclosure includes various modifications, equivalents, and/or alternatives of embodiments described herein. With regard to description of drawings, similar components may be marked by similar reference numerals.

In describing components of embodiments of the present disclosure, the terms first, second, A, B, (a), (b), and the like may be used herein. These terms are only used to distinguish one component from another component. These terms do not limit the corresponding components irrespective of the order or priority of the corresponding components. Furthermore, unless otherwise defined, all terms including technical and scientific terms used herein have the same meaning as generally understood by those having ordinary skill in the art to which the present disclosure pertains. Such terms as those defined in a generally used dictionary should be interpreted as having meanings equal to the contextual meanings in the relevant field of art, should not be interpreted as having ideal or excessively formal meanings unless clearly defined as having such in the present disclosure.

The terms, such as “first”, “second”, “1st”, “2nd”, or the like used in the present disclosure may be used to refer to various components regardless of the order and/or the priority and to distinguish one component from another component. However, these terms do not limit the components. For example, a first user device and a second user device indicate different user devices, irrespective of the order and/or priority of the user devices. For example, without departing from the scope of the present disclosure, a first component may be referred to as a second component, and similarly, a second component may be referred to as a first component.

In the present disclosure, the expressions “have”, “may have”, “include” and “comprise”, or “may include”, “may comprise”, or the like indicate existence of corresponding features (e.g., components such as numeric values, functions, operations, or parts), but do not exclude presence of additional features.

It should be understood that when a component (e.g., a first component) is referred to as being “(operatively or communicatively) coupled with/to” or “connected with/to” another component (e.g., a second component), the first component may be directly coupled with/to or connected with/to the second component or an intervening component (e.g., a third component) may be present between the first component and the second component. In contrast, when a component (e.g., a first component) is referred to as being “directly coupled with/to” or “directly connected with/to” another component (e.g., a second component), it should be understood that there is no intervening component (e.g., a third component) between the first component and the second component.

According to the situation, the expression “configured to” used in the present disclosure may be used interchangeably with, for example, the expression “suitable for”, “having the capacity to”, “designed to”, “adapted to”, “made to”, or “capable of”.

The term “configured to” does not necessarily mean “specifically designed to” in hardware. Rather, the expression “a device configured to” may mean that the device is “capable of” operating together with another device or other parts. For example, a “processor configured to perform A, B, and C” may mean a generic-purpose processor (e.g., a central processing unit (CPU) or an application processor) that may perform corresponding operations by executing one or more software programs which store a dedicated processor (e.g., an embedded processor) for performing a corresponding operation or a memory device.

Terms used in the present disclosure are used to describe specified embodiments and are not intended to limit the scope of another embodiment. The terms of a singular form may include plural forms unless the context clearly indicates otherwise. All the terms used herein, including technical or scientific terms, may have the same meaning that is generally understood by a person having ordinary skill in the art described in the present disclosure. It should be further understood that terms that are defined in a dictionary and commonly used should also be interpreted as is customary in the relevant related art and not in an idealized or overly formal manner unless expressly so defined herein in various embodiments of the present disclosure. In some cases, even though terms are terms that are defined in the specification, the terms should not be interpreted to exclude embodiments of the present disclosure.

In the present disclosure, the expressions “A or B”, “at least one of A or/and B”, or “one or more of A or/and B”, or the like may include any and all combinations of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Furthermore, in describing an embodiment of the present disclosure, each of such phrases as “A or B”, “at least one of A and B”, “at least one of A or B”, “A, B, or C”, “at least one of A, B, and C”, “at least one of A, B, or C”, and “at least one of A, B, or C, or any combination thereof” may include any one of, or all possible combinations of the items enumerated together in a corresponding one of the phrases. For example, the phrase such as “at least one of A, B, or C, or any combination thereof” may include “A”, “B”, or “C”, or “AB” or “ABC”, which is a combination thereof.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, apparatus, and the like may separately embody or be included with a processor and a memory, such as a non-transitory computer readable media, as part of the apparatus.

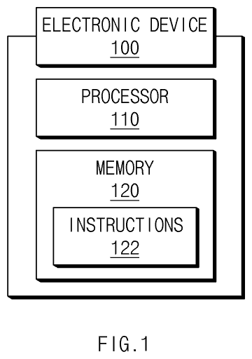

Hereinafter, embodiments of the present disclosure are described in detail with reference to FIGS. 1-10.

FIG. 1 is a drawing illustrating a block diagram of an electronic apparatus according to an embodiment of the present disclosure.

An electronic device 100 according to an embodiment may include a processor 110 and a memory 120 storing computer-instructions 122.

The electronic device 100 may be a device that performs weight lightening or reduction of a neural network. For example, the electronic device 100 may identify the neural network. The electronic device 100 may identify layers of the neural network. The electronic device 100 may determine some of the layers of the neural network as a group. The electronic device 100 may train learnable masks corresponding to the group. The electronic device 100 may determine groups that are not important in computation of the neural network among several groups, based on the learnable mask.

The electronic device 100 may define importance of the group as a learnable weight (e.g., the learnable mask). As the training of the neural network progresses, the electronic device 100 may mainly perform pruning of groups with unimportant information among the groups. As a result, the electronic device 100 may perform more optimized weight lightening or reduction for a complex network.

The electronic device 100 may control a mobility system, based on the neural network, the weight lightening of which is performed, (e.g., the neural network, the pruning of which is performed). For example, the mobility system may include, but is not limited to, at least one of a vehicle, a robot, an aircraft, or any combination thereof. The electronic device 100 may apply mobility data to the neural network to obtain an output.

Illustratively, the electronic device 100 may apply mobility data of a weight of a vehicle to the neural network to obtain an output of a predicted fuel efficiency of the vehicle. The electronic device 100 may apply the output to the mobility system to control the mobility system. The neural network, the weight lightening (i.e., reduction or pruning) of which is performed, may be embedded in the mobility system. In an embodiment, the electronic device 100 may obtain a more optimized output, for example in an environment with a limited computational resource.

The processor 110 may execute software and may control at least one other component (e.g., a hardware or software component) connected with the processor 110. In addition, the processor 110 may perform a variety of data processing or computation functions. For example, the processor 110 may store the neural network in the memory 120. For reference, the processor 110 may perform all operations performed by the electronic device 100. Therefore, for convenience of description in the specification, the operation performed by the electronic device 100 is mainly described as an operation performed by the processor 110.

Furthermore, for convenience of description in the specification, the processor 110 is mainly described as, but not limited to, one processor. For example, the electronic device 100 may include at least one processor. Each of the at least one processor may perform all operations associated with a pruning operation of the neural network.

The memory 120 may temporarily and/or permanently store various pieces of data and/or information required to perform the pruning of the neural network. For example, the memory 120 may store at least one of the neural network, the learnable mask, or the mobility data, or any combination thereof.

The electronic apparatus 100 may further include a communication device. The communication device may assist in performing communication between the electronic device 100 and a server. For example, the communication device may include one or more components for performing communication between the electronic device 100 and the server. As some examples, the communication device may include a short range wireless communication unit, a microphone, or the like. For example, a short range communication technology may be, but is not limited to, a wireless LAN (Wi-Fi), Bluetooth, ZigBee, Wi-Fi Direct (WFD), ultra-wideband (UWB), infrared data association (IrDA), Bluetooth low energy (BLE), near field communication (NFC), or the like.

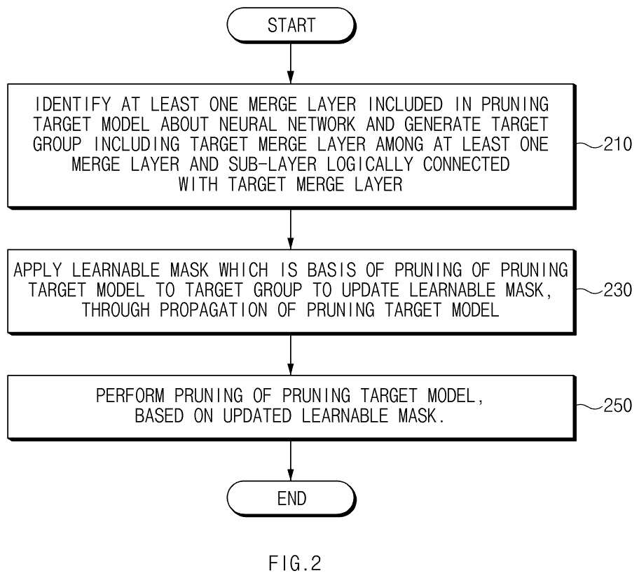

FIG. 2 is a flowchart for describing a method for performing pruning of a neural network in a processor according to an embodiment of the present disclosure.

In an operation 210, a processor (e.g., the processor 110 of FIG. 1) according to an embodiment may identify at least one merge layer included in a pruning target model of a neural network and may generate a target group including a target merge layer among the at least one merge layer and a sub-layer logically connected with the target merge layer.

For example, the pruning target model may be a model of the neural network, the pruning of which is performed. The pruning target model may include the neural network. The neural network may include a plurality of layers. Each layer may include a plurality of nodes. A node may have a node value determined based on an activation function. A node of any layer may be connected with a node (e.g., another node) of another layer through a link (e.g., a connection edge) with a connection weight. The node value of the node may be propagated to other nodes through the link. In an inference operation of the neural network, node values may be forward propagated in the direction of a next layer from a previous layer.

In an example, the forward propagation computation in the pruning target model may be computation of propagating a node value based on input data, in the direction facing the output layer from the input layer of the pruning target model. In other words, a node value of the node may be propagated (e.g., forward propagated) to a node (e.g., a next node) of a next layer connected with the node through the connection edge. For example, the node may receive a value weighted by the connection weight from a previous node (e.g., a plurality of nodes) connected through the connection edge.

For example, the node value of the node may be determined based on applying the activation function to the sum (e.g., weighted sum) of weighted values received from previous nodes. The parameter of the neural network may illustratively include the above-mentioned connection weight. The parameter of the neural network may be updated to change in a direction in which an objective function value, described in more detail below, is targeted (e.g., a direction in which a loss is minimized).

In an example, the trained pruning target model may indicate a model trained through machine learning and may be a trained machine learning model that outputs a training output from a training input. The machine learning model (e.g. the trained pruning target model) may be generated through machine learning. A learning algorithm may include, for example, but is not limited to, supervised learning, unsupervised learning, semi-supervised learning, or reinforcement learning.

In various embodiments, the training pruning target model may be, but is not limited to, a combination of at least one of a deep neural network (DNN), a convolutional neural network (CNN), a U-net for image segmentation (U-net), a recurrent neural network (RNN), a restricted Boltzmann machine (RBM), a deep belief network (DBN), a bidirectional recurrent deep neural network (BRDNN), deep Q-networks, or any combination thereof.

For supervised learning, the machine learning model may be trained based on training data including a pair of a training input and a training output mapped to the training input. For example, the machine learning model may be trained to output a training output based on a training input. The machine learning model while being trained may generate a temporary output in response to the training input and may be trained such that a loss between the temporary output and the training output (e.g., a training target) is minimized. A parameter of the machine learning model during a learning process (e.g., a connection weight between nodes/layers in the neural network) may be updated according to the loss. Such learning may be performed in the electronic device (e.g., the electronic device 100 of FIG. 1) itself, the machine learning model of which is performed, and may be performed based on a separate server. The machine learning model, the training of which is performed (e.g., is completed), (e.g., the trained pruning target model) may be stored in a memory (e.g., a memory 120 of FIG. 1).

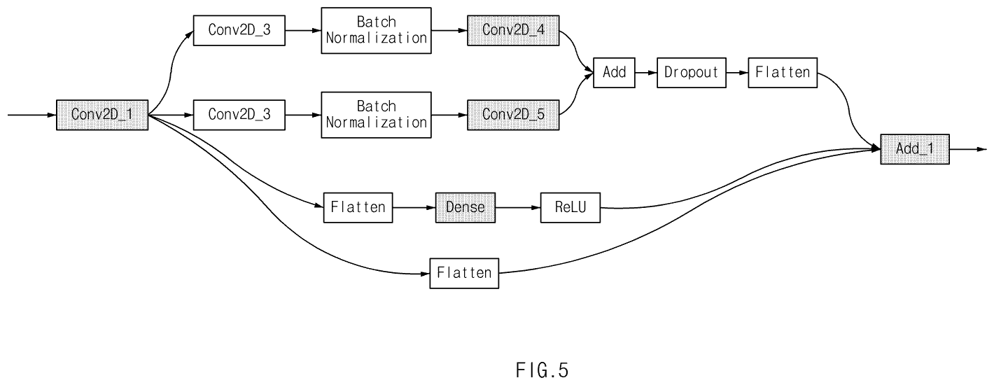

The merge layer may be a layer in which sub-layers are merged with each other. For example, if the pruning target model is a model of the CNN, the merge layer may include a layer of at least one of Add, Multiplication, Concatenate, or any combination thereof. The sub-layer may indicate a layer logically connected with the merge layer. The target group may be a group including the merge layer and the sub-layer. A detailed description of a method for identifying the merge layer and the sub-layer, according to an embodiment, is provided below with reference to FIG. 5.

In an example, the processor may generate the target group including the target merge layer among the at least one merge layer and the sub-layer logically connected with the target merge layer. In an embodiment, the number of the generated target groups may be the same as the number of the identified merge layers. In other words, the processor may generate a target group for each identified merge layer. Illustratively, if the at least one merge layer includes a first merge layer, a second merge layer, and a third merge layer, the processor may generate a first target group, a second target group, and a third target group.

For example, the first target group may include the first merge layer and a sub-layer logically connected with the first merge layer. The second target group may include the second merge layer and a sub-layer logically connected with the second merge layer. The third target group may include the third merge layer and a sub-layer logically connected with the third merge layer.

In an operation 230, the processor may apply a learnable mask that is the basis of pruning of the pruning target model to the target group to update the learnable mask, through propagation of the pruning target model. The learnable mask may include at least one element. Each of the at least one element may be collectively applied to the layers included in the target group. For example, the processor may perform a multiply operation of each of the layers included in the target group and each of the elements included in the learnable mask.

In an example, the propagation of the pruning target model may include forward propagation and back propagation. The processor may update the learnable mask, through propagation of the pruning target model in which the learnable mask is applied to the layers included in the target group.

In an example, the number of learnable masks may be the same as the number of target groups. For example, if generating the first target group, the second target group, and the third target group, the processor may generate a first learnable mask, a second learnable mask, and a third learnable mask.

The processor may apply the first learnable mask to the first target group. The processor may apply the second learnable mask to the second target group. The processor may apply the third learnable mask to the third target group.

The processor may update the learnable mask (e.g., the first learnable mask, the second learnable mask, and the third learnable mask), through the propagation of the pruning target model.

In an operation 250, the processor may perform the pruning of the pruning target model, based on the updated learnable mask. For example, the processor may change values included in the layers included in the target group (e.g., a weight connecting a node and a node, that may be represented as a matrix) to a predetermined value (e.g., 0), based on the updated learnable mask.

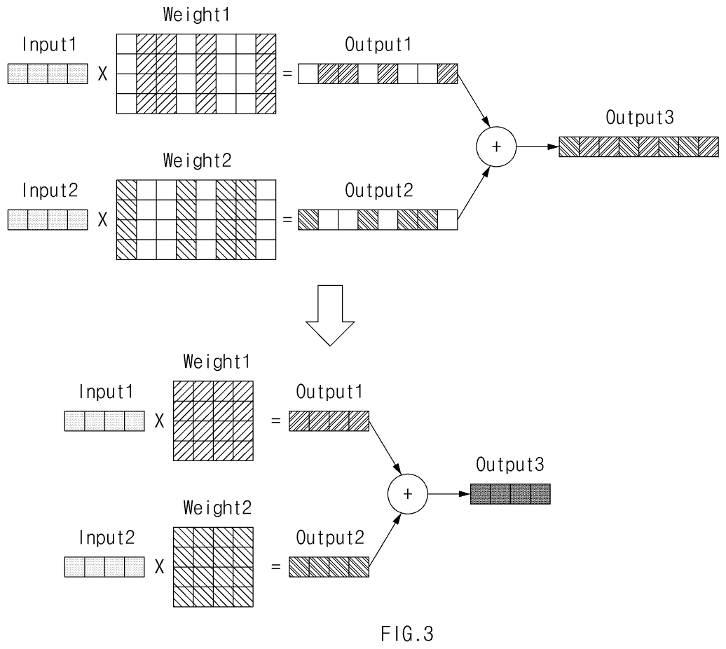

FIG. 3 is a drawing illustrating an example of not performing group-based pruning.

Referring to FIG. 3, FIG. 3 illustrates an example of computation of a neural network, if group-based pruning is not performed.

A processor (e.g., the processor 110 of FIG. 1) according to an embodiment may obtain a first output (e.g., Output 1 of FIG. 3), based on computation of a first input (e.g., Input 1 of FIG. 3) and a first weight (e.g., Weight 1 of FIG. 3).

The processor may obtain a second output (e.g., Output 2 of FIG. 3), based on computation of a second input (e.g., Output 2 of FIG. 3) and a second weight (e.g., Weight 2 of FIG. 3).

For example, the first input and the second input may be values of a node of a neural network. The first weight and the second weight may be connection weights between a node of the neural network and another node of the neural network.

For example, a pruning operation may indicate an operation of changing a value included in the connection weight to a predetermined value, in a layer including a node (e.g., an input node), the connection weight (e.g., a weight), and a node (e.g., an output node).

For example, as shown in FIG. 3, the processor may perform pruning of each of the first weight and the second weight. In an embodiment, the processor may change a value included in a first area included in the first weight (e.g., a first column, a fourth column, a sixth column, and a seventh column in the first weight) to the predetermined value. The processor may change a value included in a second area included in the second weight (e.g., a second column, a third column, a fifth column, and an eighth column in the second weight) to the predetermined value.

In an example, the processor may obtain the first output, based on computation of the first input and the first weight, the pruning of which is performed in the first area.

In an example, the processor may obtain the second output, based on computation of the second input and the second weight, the pruning of which is performed in the second area.

For example, the processor may add the first output and the second output to obtain a third output (e.g., Output 3 of FIG. 3).

Herein, because channels of the first output and the second output are different from each other, the third output may have a channel which is more increased than the channels of the first output and the second output. In other words, computation in which two feature maps (e.g., the first output and the second output) are added, for example, summation operation, may fail to obtain a weight-lightened output, if the pruned channels are the same as each other. In other words, because the pruning of the first weight is performed in the first area and the pruning of the second weight is performed in the second area, if outputs with different channels are added, the output of summation operation may fail to have a weight-lightened and/or reduced channel.

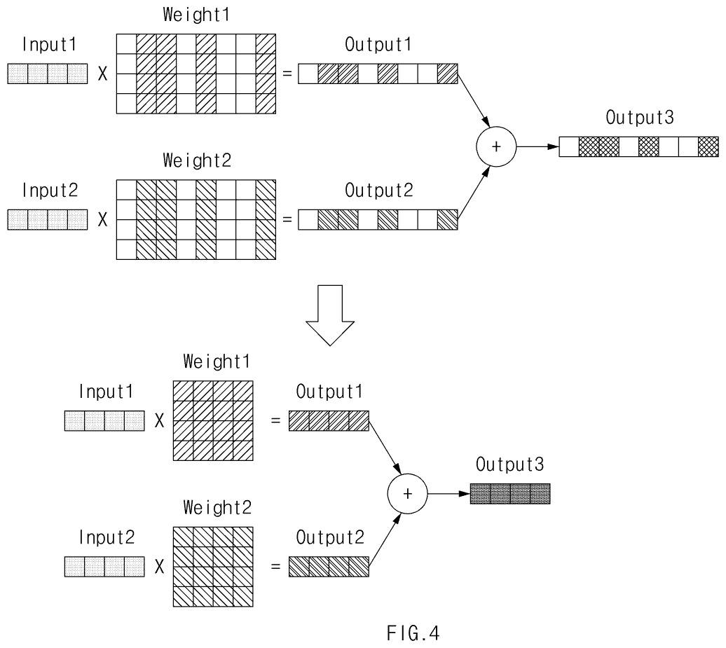

FIG. 4 is a drawing illustrating an example of performing group-based pruning.

Referring to FIG. 4, FIG. 4 illustrates an example of computation of a neural network, if group-based pruning is performed.

A processor (e.g., the processor 110 of FIG. 1) according to embodiment may obtain a first output (e.g., Output 1 of FIG. 4), based on computation of a first input (e.g., Input 1 of FIG. 4) and a first weight (e.g., Weight 1 of FIG. 4).

The processor may obtain a second output (e.g., Output 2 of FIG. 4), based on computation of a second input (e.g., Input 2 of FIG. 4) and a second weight (e.g., Weight 2 of FIG. 4).

In example, the first input and the second input may be values of a node of a neural network. The first weight and the second weight may be connection weights between a node of the neural network and another node of the neural network.

For example, as shown in FIG. 4, the processor may perform pruning of each of the first weight and the second weight. In an embodiment, the processor may change a value included in a target area included in the first weight (e.g., a first column, a fourth column, a sixth column, and a seventh column in the first weight) to a predetermined value. The processor may change a value included in a target area included in the second weight to the predetermined value.

In an example, the processor may obtain the first output, based on computation of the first input and the first weight, the pruning of which is performed in the first area.

In an example, the processor may obtain the second output, based on computation of the second input and the second weight, the pruning of which is performed in the second area.

For example, the processor may add the first output and the second output to obtain a third output (e.g., Output 3 of FIG. 4).

Herein, because channels of the first output and the second output are the same as each other, the third output may have a channel which is the same as the channels of the first output and the second output. In other words, computation in which two feature maps (e.g., the first output and the second output) are added, for example, summation operation, may obtain a weight-lightened output, because the pruned channels are the same as each other. In other words, because the pruning of the first weight and the second weight is performed in the target area, if outputs with the same channel are added, the output of summation operation may have a weight-lightened and/or reduced channel.

Unlike the pruning described in FIG. 3, the pruning described in FIG. 4 may be pruning based on a group. For example, the pruning based on the group may perform pruning of each of sub-layers logically connected with a merge layer included in the group in the same area and the same channel. As a result, the processor may perform the pruning based on the group to obtain an output, the number of channels of which is reduced. Hereinafter, a detailed description of the operation of performing the pruning depending on the weight of each of the layers included in the group, in the group-based pruning, according to an embodiment, is provided with reference to FIGS. 5-7.

FIG. 5 is a drawing illustrating a computational graph for describing a method for identifying a merge layer, in an electronic device according to an embodiment of the present disclosure.

A processor (e.g., the processor 110 of FIG. 1) according to an embodiment may identify a merge layer included in a pruning target model. The processor may determine a target group including the merge layer and a sub-layer. The processor may apply a learnable mask to each of the layers included in the target group and may update the learnable mask, through propagation of the pruning target model. The processor may perform pruning of the pruning target model, based on the updated learnable mask.

For example, the processor may identify at least one merge layer in the pruning target model. Illustratively, the processor may identify a first merge layer and second to nth merge layers. The processor may determine a target group every identified merge layers. For example, the processor may determine a first target group including the first merge layer, may determine a second target group including the second merge layer, and may determine an nth target group including the nth merge layer.

In an example, the processor may apply respective learnable masks every target groups. As a result, the processor may perform group-based pruning. Furthermore, the processor may differently perform pruning of layers included in each group for each group based on the learnable mask, rather than equally performing pruning of the layers included in each group, to perform the group-based pruning. A method for identifying a merge layer, determining a target group including the merge layer, and applying the learnable mask to the target group in the processor, according to an embodiment, is described in more detail below with reference to FIGS. 5-8.

For example, the processor may identify the merge layer, based on a computational graph of the pruning target model. Referring to FIG. 5, FIG. 5 illustrates a computational graph of a pruning target model. The pruning target model with the computational graph shown in FIG. 5 may be a model of a CNN.

For example, the processor may identify a merge layer in which layers are merged and/or connected with each other, on the computational graph. Illustratively, the processor may identify an “Add” layer as the merge layer, on the computational graph. For the merge layer shown in FIG. 5, the merge layer may be connected with a convolution layer, a “Dense” layer, and a “Flatten” layer.

For example, if identifying the merge layer, the processor may identify a sub-layer logically connected with the merge layer. Illustratively, if identifying the “Add” layer as the merge layer, the processor may identify a “Conv2D_1” layer, a “Conv2D_4” layer, a “Conv2D_5”, and a “Dense” layer as sub-layers logically connected with the merge layer.

For example, if identifying the merge layer and the sub-layer, the processor may determine the target group including the merge layer and the sub-layer. In other words, the target group may include the merge layer (e.g., the “Add” layer) and the sub-layers (e.g., the “Conv2D_1” layer, the “Conv2D_4” layer, the “Conv2D_5” layer, and the “Dense” layer).

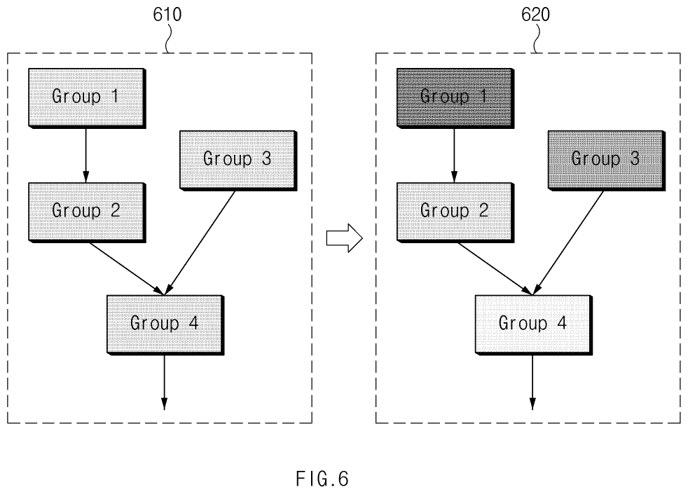

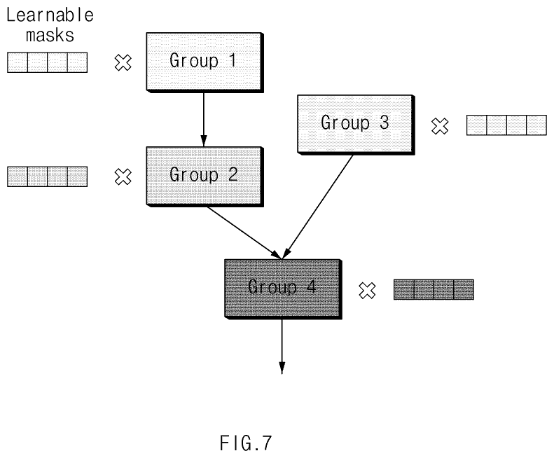

FIGS. 6 and 7 are drawings illustrating an example of performing group-based pruning depending on importance of each of groups, in an electronic device according to an embodiment of the present disclosure.

Referring to FIG. 6, FIG. 6 illustrates an example of performing group-based pruning depending on importance of each of groups.

A processor (e.g., the processor 110 of FIG. 1) according to embodiment may generate a target group every merge layers included in a pruning target model.

For example, the example in which the processor generates the target group based on the pruning target model may be a first state 610. In detail, the first state 610 may be an example of visualizing the pruning target model, which may include 4 target groups. Each of the 4 target groups (e.g., Group 1, Group 2, Group 3, and Group 4 of FIG. 6) may include a merge layer and a sub-layer. The processor may apply a learnable mask to each of the 4 target groups.

For example, the example in which the processor performs pruning of the pruning target model based on the updated learnable mask may be a second state 620. In detail, the second state 620 may indicate an example in which the processor performs pruning of the pruning target model in the first state 610.

For example, referring to the second state 620, pruning of each target group may be performed in a different level. In detail, the processor may apply a first learnable mask to the first target group (e.g., Group 1) in the first state 610 to obtain the first target group in the second state 620.

For example, the pruning target model may be composed of several target groups. Sensitivity by pruning or importance upon inference may vary for each target group. Illustratively, the first target group and the fourth target group (e.g., Group 4) may vary in influence on network performance. The processor may apply a different learnable mask for each target group to consider the sensitivity or the importance for each target group. On the other hand, if applying the same learnable mask for each target group (i.e., if aiming at the same scarcity to proceed with pruning of all target groups), the result of the pruning may cause deterioration in network performance.

Referring to FIG. 7, FIG. 7 illustrates an example of applying a learnable mask to each target group included in the second state 620 of FIG. 6.

For example, the processor may individually determine scarcity (e.g., indicating a degree to which pruning is performed) for each target group, based on learnable importance (e.g., the learnable mask) between target groups.

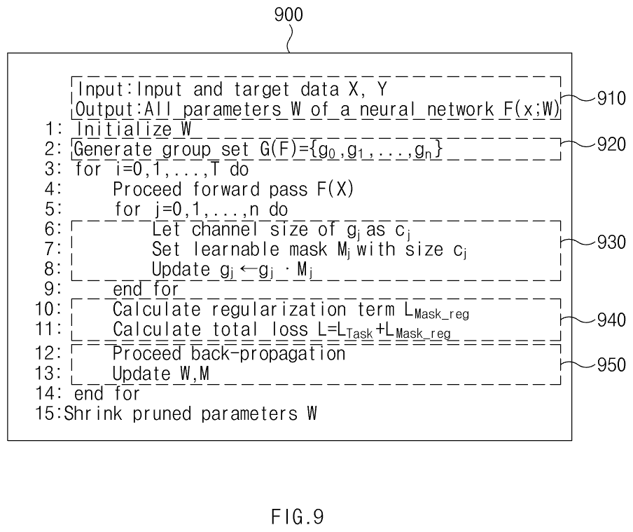

In detail, the processor may apply a different learnable mask to each target group to perform pruning with different scarcity, depending on importance of each target group. Herein, the learnable mask may be trained and/or updated in the direction of minimizing deterioration in performance of the network (i.e., the pruning target model). Furthermore, the learnable mask may be set in various manners. A more detailed description of the method for training and/or updating the learnable mask, according to an embodiment, is provided below with reference to FIG. 9.

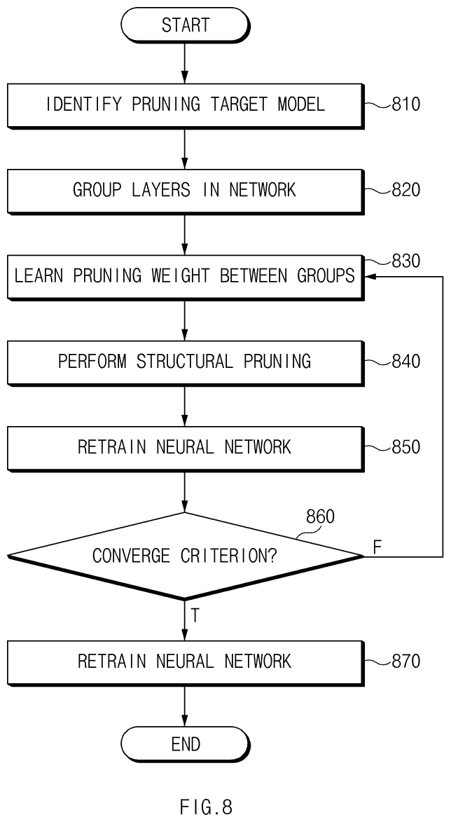

FIG. 8 is a flowchart for describing a method for performing pruning and training of a neural network, in an electronic device according to an embodiment of the present disclosure.

In an operation 810, a processor (e.g., the processor 110 of FIG. 1) according to embodiment may identify a pruning target model. For example, the processor may obtain the pruning target model from a server through a communication device. The processor may store the obtained pruning target model in a memory (e.g., the memory 120 of FIG. 1).

In an operation 820, the processor may group layers in a network (e.g., the pruning target model). For example, the processor may identify the pruning target model to determine a target group including a merge layer and a sub-layer logically connected with the merge layer. The processor may determine target groups, each of which includes each of merge layers included in the pruning target model and a sub-layer connected with each of the merge layers.

In an operation 830, the processor may learn a pruning weight between groups. For example, the pruning weight may indicate a learnable mask.

The processor may forward propagate and back propagate the pruning target model including at least one target group (i.e., learn the pruning weight) to obtain a loss.

The processor may update the learnable mask, based on a loss to which a predetermined regularization term is applied. Herein, the loss may be a loss for training the pruning target model.

Illustratively, the processor may identify a first merge layer and a second merge layer from at least one merge layer. The processor may generate a first target group including the first merge layer and a first sub-layer logically connected with the first merge layer and may generate a second target group including the second merge layer and a second sub-layer logically connected with the second merge layer.

The processor may apply a first learnable mask to the first target group and may apply a second learnable mask to the second target group. Herein, the first learnable mask and the second learnable mask may be different masks. The processor may update the first learnable mask and the second learnable mask.

In an operation 840, the processor may perform structural pruning.

For example, the processor may change values included in the layers included in the target group to a predetermined value to perform pruning of the pruning target model, based on the updated learnable mask. For example, the processor may change the values included in the target group to predetermined “0” to deactivate intervention of the layer in a computation process of the pruning target model.

In an operation 850, the processor may retrain a neural network (i.e., the pruning target model).

For example, the processor may receive input data and target data. The processor may initialize all parameters of the pruning target model and may apply the input data to the pruning target model to propagate (i.e., retrain) the pruning target model. The processor may update the learnable mask, based on comparison between a temporary output obtained by propagating the pruning target model and the target data.

In an operation 860, the processor may determine a converge criterion of the pruning target model.

For example, the processor may determine whether the pruning target model in which the layers included in the target group are updated satisfies a predetermined converge criterion. Herein, the predetermined converge criterion may include whether it changes in a direction in which an objective function value or a loss is targeted (e.g., a direction in which the loss is minimized).

The processor may perform an operation (e.g., operation 840) of performing the pruning of the pruning target model from an operation (e.g., operation 830) of applying the learnable mask to the target group, based on that the pruning target model does not satisfy the converge criterion.

In an operation 870, the processor may obtain the weight-lightened neural network (i.e., the pruning target model, the pruning of which is performed). The processor may end the pruning and retraining of the pruning target model, based on that the pruning target model satisfies the converge criterion.

The processor may apply mobility data to the pruning target model, the pruning of which is performed, to obtain an output. The processor may apply the output to a mobility system to control the mobility system.

FIG. 9 is a drawing illustrating an example of a pseudo code of instructions executed by a processor, in an electronic device according to an embodiment of the present disclosure.

A processor (e.g., the processor 110 of FIG. 1) according to embodiment may execute instructions included in a pseudo code 900. The processor may execute the instructions included in the pseudo code 900 to perform pruning and retraining of a pruning target model.

For example, a first code 910 may include an input and an output of the pseudo code 900. Illustratively, the input may include a training input and a training output to be used to train the pruning target model. The output may include all parameters of the pruning target model (i.e., a connection weight of the pruning target model).

For example, a second code 920 may include a command to determine a target group. For example, if there are n merge layers in the pruning target model, the processor may perform the second code 920 to determine and/or obtain n target groups.

For example, a third code 930 may include a command to apply a learnable mask to the target group. For example, if executing the third code 930, the processor may set the size of the learnable mask to a channel size of the target group. If setting the size of the learnable mask, the processor may apply the learnable mask, the size of which is set, to the target group.

For example, a fourth code 940 may include a command to obtain a loss, which is the basis of updating the learnable mask and updating a parameter (i.e., a connection weight) included in the pruning target model.

In detail, if executing the fourth code 940, the processor may obtain a first loss (e.g., shown as L_{Task} in FIG. 9), based on a difference between a temporary output (i.e., an output obtained by applying the input data to the pruning target model) and target data (i.e., ground truth). The processor may obtain a second loss (e.g., shown as L_{Mask_reg} in FIG. 9) of a regularization term, based on whether a predetermined value is included in the learnable mask.

For example, the second loss may be represented by Equation 1 below.

$${L}_{Mask\_reg} = {\sum }_{i = 1}^{n} I ( m = 0 \vert m ∈ {M}_{i} ) \qquad [ Equation 1 ]$$

Herein, I may refer to the indicator function, may return 1 if condition (m=0|m∈Mᵢ) is true, and may return 0 when it is false, and Mᵢ may refer to the learnable mask. In other words, Equation 1 above may be the loss used to remove an unnecessary connection from a neural network or make the weight “0” to make the network (e.g., the pruning target model) rare, based on the number of 0 in the target mask.

The processor may update the learnable mask and/or may update a parameter included in the pruning target model, based on the first loss and the second loss.

For example, a fifth code 950 may include a command to update the learnable mask and update the parameter included in the pruning target model.

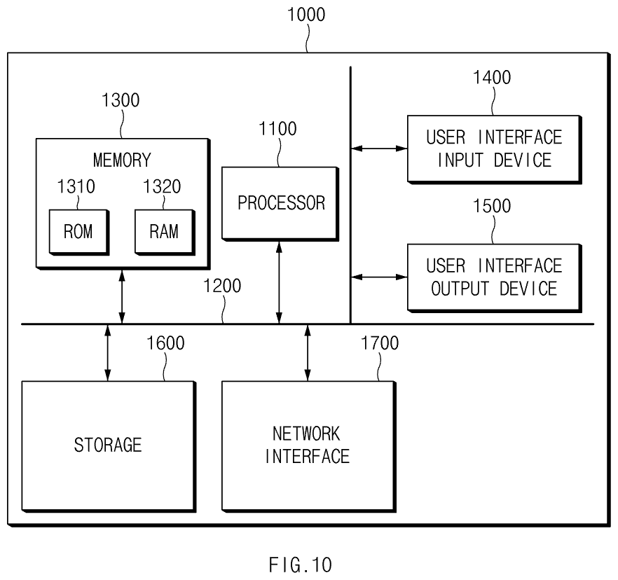

FIG. 10 is a drawing illustrating a computing system that may be used with an electronic device or a method for performing pruning of a neural network according to an embodiment of the present disclosure.

Referring to FIG. 10, a computing system 1000 that may be used with the electronic device or the method for performing the pruning of the neural network may include at least one processor 1100, a memory 1300, a user interface input device 1400, a user interface output device 1500, storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The storage medium may be coupled to the processor 1100. The processor 1100 may read out information from the storage medium and may write information in the storage medium. Alternatively, the storage medium may be integrated with the processor 1100. The processor 1100 and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to certain embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims.

The above-described embodiments may be implemented with hardware components, software components, and/or a combination of hardware components and software components. For example, the devices, methods, and components described in the embodiments may be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute instructions and respond. A processing unit may perform an operating system (OS) or a software application running on the OS. Further, the processing unit may access, store, manipulate, process and generate data in response to execution of software. It should be understood by those skilled in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively instruct the processing unit. Software and/or data may be permanently or temporarily embodied in any type of machine, components, physical equipment, virtual equipment, computer storage media or units or transmitted signal waves so as to be interpreted by the processing unit or to provide instructions or data to the processing unit. Software may be dispersed throughout computer systems connected over networks and be stored or executed in a dispersion manner. Software and data may be recorded in one computer-readable storage media.

The methods according to embodiments of the present disclosure may be implemented in the form of program instructions which may be executed through various computer means and may be recorded in computer-readable media. The computer-readable media may include program instructions, data files, data structures, and the like alone or in combination, and the program instructions recorded on the media may be specially designed and configured for an example or may be known and usable to those skilled in the art of computer software. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Program instructions include both machine codes, such as produced by a compiler, and higher level codes that may be executed by the computer using an interpreter.

The above-described hardware devices may be configured to act as one or a plurality of software modules to perform the operations of the embodiments, or vice versa.

Even though the embodiments are described with reference to restricted drawings, it should be apparent to one having ordinary skill in the art that the embodiments are variously changed or modified based on the above description. For example, adequate effects may be achieved even if the foregoing processes and methods are carried out in different order than described above, and/or the aforementioned components, such as systems, structures, devices, or circuits, are concatenated or coupled in different forms and modes than as described above or be substituted or switched with other components or equivalents.

A description of effects of the electronic device and the pruning method of the neural network according to embodiments of the present disclosure is provided herein below.

According to at least one of embodiments of the present disclosure, the electronic device may perform pruning of a pruning target model, based on a learnable mask, thus individually applying importance every groups to proceed with pruning, in group-based pruning.

Furthermore, according to at least one of embodiments of the present disclosure, the electronic device may control a mobility system based on the pruning target model, the pruning of which is performed, thus applying a more optimized AI model to an environment with a limited computational resource.

In addition, various effects ascertained directly or indirectly through the present disclosure may be provided.

Therefore, other implements, other embodiments, and equivalents to claims are within the scope of the following claims.

Therefore, embodiments of the present disclosure are not intended to limit the technical spirit of the present disclosure, but provided only for illustrative purpose. The scope of the present disclosure should be construed on the basis of the accompanying claims, and all the technical ideas within the scope equivalent to the claims should be included in the scope of the present disclosure.

What is claimed is:

1. An electronic device, comprising:
a memory storing computer-readable instructions; and
at least one processor coupled to the memory, the at least one processor configured to execute the computer-readable instructions to:
identify one or more merge layers included in a pruning target model of a neural network;
generate a target group including layers, the layers including i) a target merge layer among the one or more merge layers and ii) a sub-layer logically connected with the target merge layer;
apply a learnable mask to the target group;
update the learnable mask through propagation of the pruning target model; and
perform pruning of the pruning target model, to generate a pruned target model, based on the updated learnable mask.

2. The electronic device of claim 1, wherein the at least one processor is configured to identify the one or more merge layers based on a computational graph of the pruning target model.

3. The electronic device of claim 1, wherein the at least one processor is configured to:
receive input data and target data;
initialize parameters of the pruning target model;
apply the input data to the pruning target model to propagate the pruning target model; and
update the learnable mask based on a comparison between a temporary output obtained by propagating the pruning target model and the target data.

4. The electronic device of claim 3, wherein the at least one processor is configured to initialize parameters of the pruning target model by initializing all parameters of the pruning target model.

5. The electronic device of claim 3, wherein the at least one processor is configured to:
obtain a first loss based on a difference between the temporary output and the target data;
obtain a second loss of a regularization term based on whether a predetermined value is included in the learnable mask; and
update the learnable mask based on the first loss and the second loss.

6. The electronic device of claim 1, wherein the at least one processor is configured to change values included in the layers included in the target group to a predetermined value to perform pruning of the pruning target model based on the updated learnable mask.

7. The electronic device of claim 1, wherein the at least one processor is configured to:
determine whether the pruning target model satisfies a predetermined converge criterion; and
perform pruning of the pruning target model by applying the learnable mask to the target group based on determining that the pruned target model does not satisfy the predetermined converge criterion.

8. The electronic device of claim 1, wherein the at least one processor is configured to set a size of the learnable mask to a channel size of the target group.

9. The electronic device of claim 1, wherein the at least one processor is configured to:
identify a first merge layer and a second merge layer from the one or more merge layers;
generate a first target group including the first merge layer and a first sub-layer logically connected with the first merge layer;
generate a second target group including the second merge layer and a second sub-layer logically connected with the second merge layer;
apply a first learnable mask to the first target group and apply a second learnable mask to the second target group, the first learnable mask and the second learnable mask being different from each other; and
update the first learnable mask and the second learnable mask to perform the pruning of the pruning target model.

10. The electronic device of claim 1, wherein the at least one processor is configured to:
apply mobility data to the pruned target model to obtain an output; and
apply the output to a mobility system to control the mobility system.

11. A method, comprising:
identifying one or more merge layers included in a pruning target model of a neural network;
generating a target group including layers, the layers including i) a target merge layer among the one or more merge layers and ii) a sub-layer logically connected with the target merge layer;
applying a learnable mask to the target group;
updating the learnable mask through propagation of the pruning target model; and
performing pruning of the pruning target model, to generate a pruned target model, based on the updated learnable mask.

12. The method of claim 11, wherein identifying the one or more merge layers includes identifying the one or more merge layers based on a computational graph of the pruning target model.

13. The method of claim 11, wherein updating the learnable mask includes:
receiving input data and target data;
initializing parameters of the pruning target model;
applying the input data to the pruning target model to propagate the pruning target model; and
updating the learnable mask based on a comparison between a temporary output obtained by propagating the pruning target model and the target data.

14. The method of claim 13, wherein initializing parameters of the pruning target model includes initializing all parameters of the pruning target model.

15. The method of claim 13, wherein updating the learnable mask includes:
obtaining a first loss based on a difference between the temporary output and the target data;
obtaining a second loss of a regularization term based on whether a predetermined value is included in the learnable mask; and
updating the learnable mask based on the first loss and the second loss.

16. The method of claim 11, wherein performing pruning of the pruning target model includes changing values included in the layers included in the target group to a predetermined value to perform pruning of the pruning target model based on the updated learnable mask.

17. The method of claim 11, wherein performing pruning of the pruning target model includes:
determining whether the pruning target model satisfies a predetermined converge criterion; and
performing pruning of the pruning target model by applying the learnable mask to the target group based on determining that the pruning target model does not satisfy the predetermined converge criterion.

18. The method of claim 11, wherein performing pruning of the pruning target model includes setting a size of the learnable mask to a channel size of the target group.

19. The method of claim 11, wherein performing pruning of the pruning target model includes:
identifying a first merge layer and a second merge layer from the one or more merge layers;
generating a first target group including the first merge layer and a first sub-layer logically connected with the first merge layer;
generating a second target group including the second merge layer and a second sub-layer logically connected with the second merge layer;
applying a first learnable mask to the first target group and applying a second learnable mask to the second target group, the first learnable mask and the second learnable mask being different from each other; and
updating the first learnable mask and the second learnable mask to perform the pruning of the pruning target model.

20. The method of claim 11, further comprising:
applying mobility data to the pruned target model to obtain an output; and
applying the output to a mobility system to control the mobility system.
